(19) United States
(12) Patent Application Publication
(10) Pub. No.: US 2004/0262061 A1
(43) Pub. Date: Dec. 30, 2004

(54) Work vehicle hood

(75) Inventors: Jesse J. Bahr, Willowbrook, IL (US); Michael C. Bunnell, Clarendon Hills, IL (US); William H. Adamson, Naperville, IL (US)

Correspondence Address: CNH AMERICA LLC, INTELLECTUAL PROPERTY LAW DEPARTMENT, PO BOX 1895, MS 641, NEW HOLLAND, PA, 17557, US

(73) Assignee: Case, LLC

(21) Appl. No.: 10/602,649

(22) Filed: Jun. 25, 2003

(51) Int. Cl. B62D 25/10; B60K 13/02

(52) U.S. Cl. 180/69.2; 180/68.3

(57) ABSTRACT

An engine hood includes an outer shell with vertical front, right and left sides and a planar top that covers an engine and its radiator. An inner panel is fixed to the inner surface of the hood underneath an opening in the top. This inner panel directs air passing through the opening in the top forward to in front of the radiator. The inner panel is fixed to the hood at its rear and side edges, and abuts the top of the radiator with it front edge. This prevents heated air flow from behind the radiator over the top of the radiator and into the radiator air inlet and the combustion air inlet.

### FIELD OF THE INVENTION

The invention relates generally to work vehicle hoods. More particularly, it relates to tractor hoods and related structures that conduct air through apertures in the hood and into the engine's air intake. Even more particularly, it relates to vehicle hoods having integrally formed ducts to conduct air therethrough from an aperture in the hood to an engine air intake.

### BACKGROUND OF THE INVENTION

Work vehicles such as tractors have hoods that surround the engine. These hoods often have apertures or openings therethrough that pass air to the engine for cooling the engine and for combustion air.

“Combustion air” refers to that air that is conducted from the atmosphere into an internal combustion engine, through an engine air intake to be there combined with fuel and is burned to produce engine power. “Cooling air” refers to that air that is conducted through a n engine radiator or other cooling device to receive heat from the radiator and thereby cool the engine.

Vehicle hoods are designed smaller, narrower and lower to give the operator a better view of the field. At the same time, engine capacities are being designed greater and greater, thereby requiring more cooling air. The result is that the traditional single engine opening that is provided in the vertical front panel or wall of the hood is no longer sufficient to provide all the cooling air and all the combustion air as well.

As a result, designers have started placing hood apertures or openings in different places in the hood. As the hood moves closer to the radiator and the radiator is moved closer to the engine, even these efforts have been difficult. Even if sufficient apertures through the hood can be located to provide air flow for cooling and for combustion, the air provided for combustion may be heated by the radiator, thus lowering the efficiency of the engine.

What is needed, therefore, is an improved work vehicle having a hood that can be located close to the engine yet can also be configured to provide sufficient apertures to permit both sufficient cooling air and sufficient combustion air to pass through. What is also needed is an improved hood that will provide sufficient cooling and combustion air to pass therethrough. What is also needed is a hood that provides air flow through the hood sufficient for cooling and for combustion, yet keeps the air paths separate to reduce radiator heating of the combustion air before it is introduced into the engine.

It is an object to provide a solution to these problems in one or more embodiments of the invention.

### SUMMARY OF THE INVENTION

In accordance with a first aspect of the invention, a tractor hood is provided having an outer shell comprised of a top panel, a front panel, a left side panel and a right side panel, the top panel defining a first aperture configured to conduct air through the hood, at least a portion of the first aperture being located behind the vehicle's engine cooling water radiator. The hood also has an inner panel or duct that is fixed to the underside of the hood adjacent the first aperture to redirect air that passes through the portion of the first aperture that is behind the radiator. The panel is configured to direct this air forward from the rear of the radiator to the front of the radiator.

The panel may abut the hood and the radiator such that substantially all air passing though the first aperture is directed to the front of the radiator. The panel may sealingly abut a combustion air intake tube such that the air intake tube extends forward and between the panel and the radiator, said air intake tube terminating at a position forward of the radiator to receive air from the inlet side of the radiator and the duct formed by the panel and the hood.

The panel may extend across the inner top panel of the outer shell of the hood from the top left side of the radiator to the top right side of the radiator.

### BRIEF DESCRIPTION OF THE DRAWINGS

FIG. 1 is a perspective view of a tractor having a hood in accordance with the present invention.

FIG. 2 is a cross-sectional right side view of the hood of FIG. 1 taken at section line 2-2 in FIG. 1 showing how the inner panel of the hood is fixed to the underside of the outer shell of the hood.

FIG. 3 is a cross-sectional front view of the hood of FIGS. 1-2 showing the radiator and inner panel, with the outer shell of the hood in cross-section generally taken at section line 3-3 in FIG. 2.

FIG. 4 is a perspective view of the inner panel.

FIGS. 5, 6 and 7 are a top, a front and a cross-sectional side views of the inner panel. The cross-sectional side view of the inner panel is taken at section line 7-7 in FIG. 5.

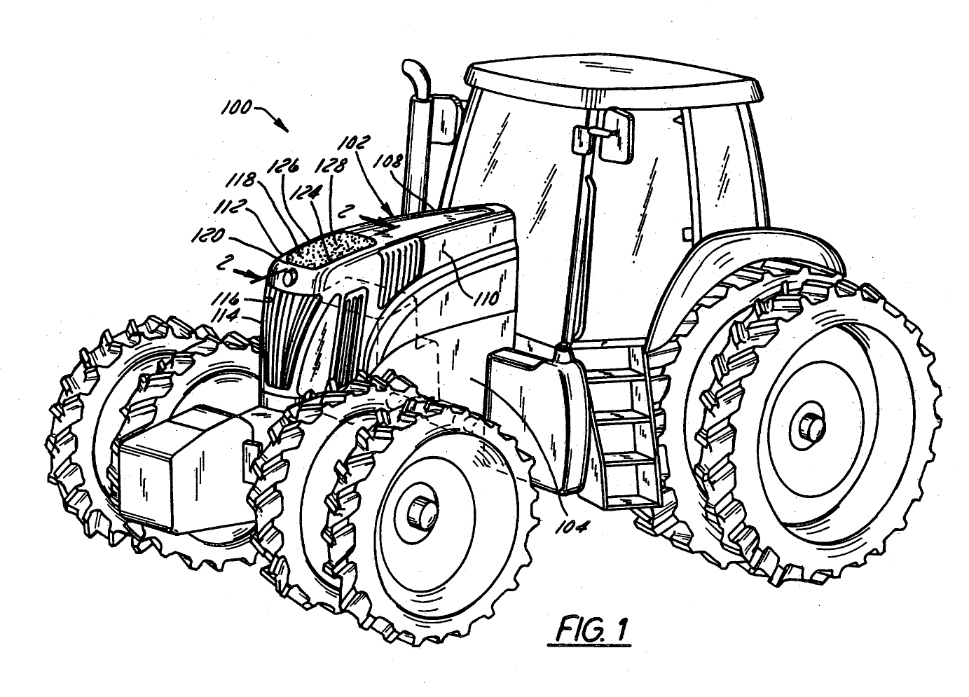

### DETAILED DESCRIPTION OF THE PREFERRED EMBODIMENTS

In the description below, certain relative directions are used, such as “forward”, “in front of”, “to the rear of”, “backward”, “in back of” or “behind”, to indicate relative positions in a horizontal direction without regard to relative vertical position and “above”, “over”, “below” and “under” to represent relative positions in a vertical direction without regard to relative horizontal position. As an example, a kite being towed by a moving car is both “behind”, “in back of” and “to the rear of” the car and “above” and “over” the car. The car is “under”, “forward of”, “in front of” and “under” the kite.

A first object is “forward” or “in front of” a second object if the first object is closer to the front of the vehicle than the second object. “Forward” is the normal direction of travel of a vehicle.

Referring now to the FIGURES, an agricultural tractor 100 has a hood 102 that is mounted on the tractor's chassis 104. Hood 102 covers engine 106, surrounding it on the front, the top, the left, and the right sides. It is, in effect, a four -sided box having an open bottom and an open back or rear wall.

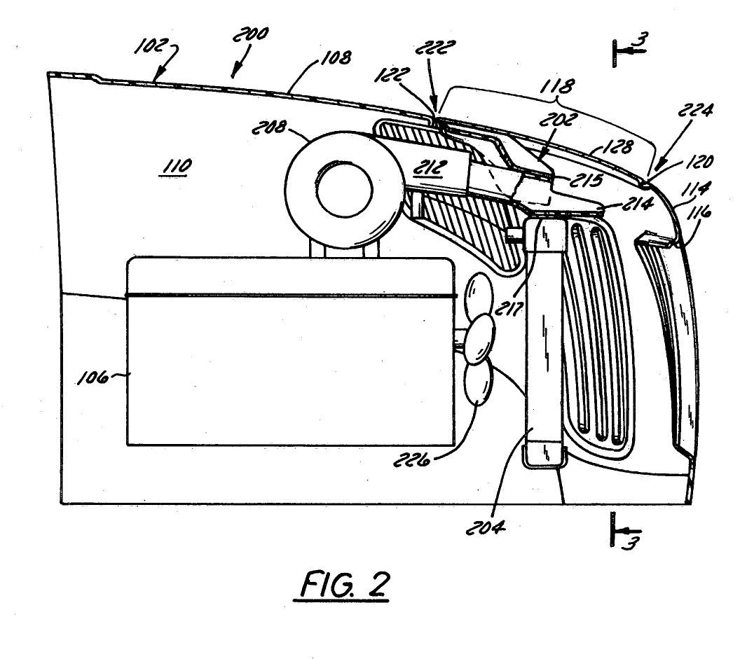

Hood 102 is relatively narrow, having a width of about 2 to 3 feet, which is sufficient to extend across the top of the engine 106 (FIG. 2) and down both the left and right sides.

Hood 102 has a generally planar, upward, facing top panel, surface or wall 108. It slopes downwardly as one moves forward along the top panel 108 toward the front of the vehicle. Top panel 108 is fixed to two side panels, surfaces or walls 110, 112 that extend downward from the left and right lateral edges of the top panel. Side panel 110 extends downward from the left edge of the top panel 108 to which it is coupled, and side panel 112 extends downward from the right edge of top panel 108 to which it is coupled.

The hood further includes a generally vertical front panel, surface or wall 114 that is coupled to and extended generally downward and forward from the front of the top panel 108. Front panel 114 is joined at its generally vertical lateral edges to the generally vertical leading edges of side panels 110 and 112. It is these four panels that constitute the four walls of the hood: the front top, left side and right side walls.

There are several apertures or openings defined in the top, front and side panels of the outer shell of the hood. The first of these is a large cooling air aperture or opening 116 in front panel 114. Cooling air opening 116 conducts the bulk of the required cooling air generally horizontally to the inlet side of the radiator and then through the radiator to cool the engine.

The cooling air opening 116 extends generally from the top to the bottom of the front panel 114 and from one side to the other side of front panel 114. It, like the front panel, faces forward in the direction of vehicle travel.

A second aperture, hole or opening 118 is located in the top panel 108 of the hood and faces upward. This top aperture, hole or opening 118 conducts combustion air from the upper surface of the hood 102, through the hood (i.e. through top panel 108) and into the combustion air intake of the vehicle's engine.

Top opening 118 is generally rectangular in shape, having a forward edge 120, a rearward edge 122 (FIG. 2), a left edge 124 and a right edge 126. It is covered with a fine mesh grille 128 that is preferably made of a perforated sheet metal that defines small openings therethrough. These small openings through the grill are preferably small circular openings of about 0.15 inches in diameter spaced approximately 0.2 inches apart.

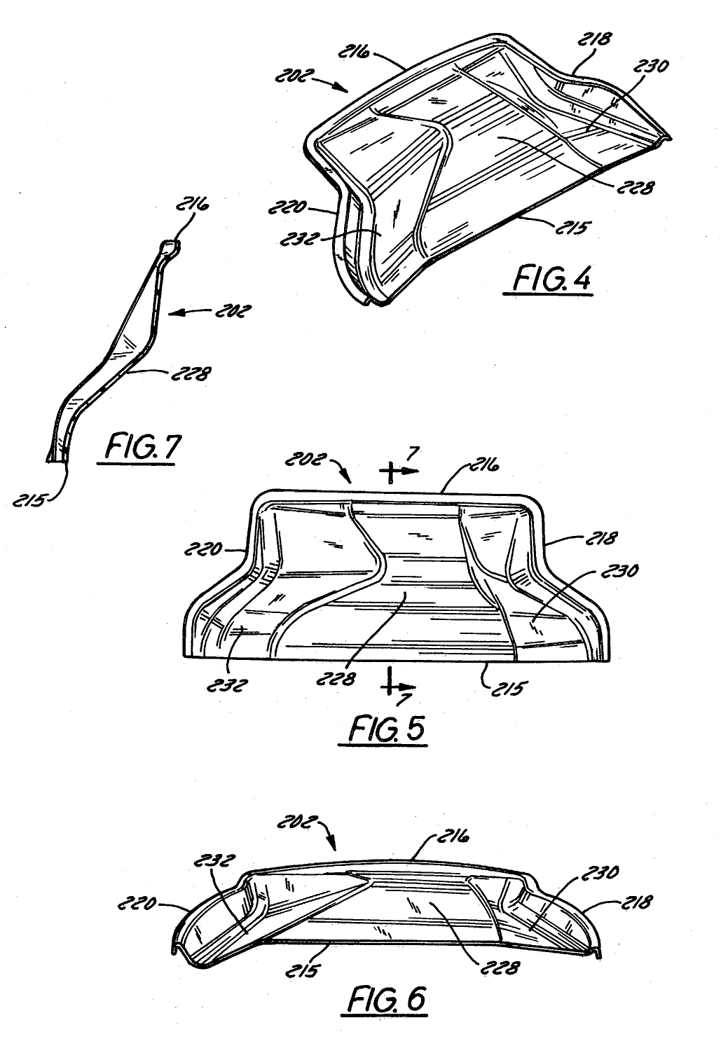

FIG. 2 is a cross-sectional side view of the hood. The hood is formed as an outer shell 200 that includes the top, front and side panels, surfaces or walls 108, 110, 112, 114 described above. It also includes specially formed inner panel or duct 202 that is fixed to the inner surface of the outer shell (e.g. fixed to the inner surface of top panel 108). This inner panel is shown by itself in more detail in FIGS. 4-7.

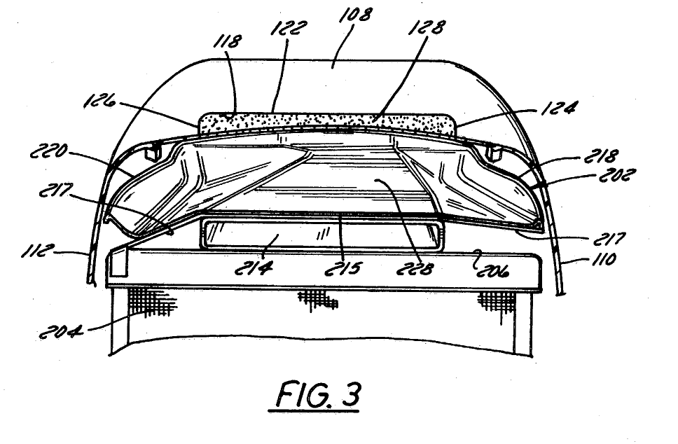

Radiator 204 is supported on the chassis (not shown) and extends generally perpendicular to the longitudinal horizontal axis of the vehicle. It has an upper surface 206 (FIG. 3) that is generally planar and horizontal, although it does slope downward at each side. (See FIG. 7). A cylindrical air cleaner 208 that extends from side-to-side is also disposed just underneath the hood 102. Extending forward from the air cleaner is a combustion air intake duct or tube 212. This duct 212 conveys outside air from its open forward end 214 to the air cleaner 208 to which it is coupled. By providing a duct 212 that extends back to the air cleaner, the combustion air can be received from any location the designers prefer. In this case, the air duct extends forward to the front of the air cleaner, whereby it can suck cool, unheated air. This cool air is much denser and provides for higher engine power output.

The combustion air intake duct 212 has a generally circular shape at its rear end where it couples to the air cleaner 208. As it extends forward, its profile changes gradually from a circular shape to a flattened oval having a width that is about six times greater than its height. This reduced profile permits the duct 212 to fit underneath the hood and permits the top panel of the outer shell of hood to be lowered until it almost touches the top of radiator 204. When the hood is lowered in this fashion it improves the operator's visual range, permitting the operator to see the ground much closer to the front of the vehicle.

Without inner panel, surface or wall 202, however, hot air from the rear side or face of the radiator (the cooling air outlet) might still be sucked over the top of the radiator into the combustion air intake duct 212 (and the front side or face of the radiator, which is the cooling air inlet of the radiator), thus reducing efficiency.

Inner panel 202 is a generally planar sheet of material having a front edge 215, a rear edge 216, a left side edge 218 and a right side edge 220. The rear edge 216 and the left and right edges 218, 220, respectively, abut and are sealed against the outer shell 200 of the hood. The front edge 215 extends downward to seal against the top of the radiator 204 and the forward end 214 of combustion air intake duct 212. In this manner, inner panel 202 seals a gap that would otherwise exist between the top of the radiator (and the combustion air intake duct 212 which rests on top of the radiator) and the hood. In this manner, inner panel 202 blocks the flow of heated engine air around the top of the radiator and into the combustion air intake duct. While front edge 215 seals against the top of radiator 204 and the open end 214 of the combustion air intake duct 212, it should be recognized that small pieces of trim or flashing, or flexible strips of material, both metal and polymeric, may be fastened to and between the radiator and intake duct, and the inner panel 202 to fill in small gaps that might permit significant quantities of air to pass though between the panel 202 and the radiator and intake duct. In this embodiment, flashing 217 (FIG. 3) is provided for that purpose.

Inner panel 202 also acts as a conduit to direct outside air that passes through top opening 118 in the top panel of the hood 102. Note that top opening 118 extends both forward and aft of the radiator. A rear portion 222 of top opening 118 is disposed horizontally behind (and vertically above) the radiator, and a front portion 224 of the opening 118 is disposed horizontally behind (and vertically above) the radiator.

Since rear portion 222 is disposed behind the radiator, were it not for inner panel 202, hot air exhausted by the fan 226 would be blown upward and outward through opening 118. Were it not for inner panel 202, some of this air blown backward and upward by fan 226 would also be sucked around and over the top of radiator 204 and would be sucked into the combustion air intake duct 212.

Without inner panel 202, the rear portion 222 of top opening 118 would not provide substantial combustion air to the engine, but would act more as an exhaust port for heated air ejected from fan 226.

For this reason, inner panel 202 is fixed to the hood along its rear edge 216, left side edge 218 and right side edge 220. Each of these edges is fixed to and abuts the underside of the outer shell portion of the hood to prevent air from being blown back up through the top opening 118. The front edge 215 of inner panel 202 extends across under the hood 102 from the left and right side panels or walls 110, 112, respectively. The front of panel 202 does not sealingly abut the hood, however, but abuts the top of the radiator and the top of the combustion air intake duct. The front edge 215 is disposed to seal against the top of the radiator and the top of the combustion air intake duct to prevent substantially all heated air from being drawn across the top of the radiator from the rear of the radiator to the front of the radiator.

The inner panel 202 is configured to direct air that is sucked through the top opening 118 from horizontally behind (and vertically above) the radiator to a position horizontally in front of (and vertically above) the radiator.

The rear edge of the inner panel 202 is fastened to and abuts the hood behind the radiator. Air sucked downward through the rear portion 222 of top opening 118 is pulled forward along the upper surface of inner panel 202 to a location in front of the radiator where it is sucked into the open end 214 of combustion air intake duct 212.

FIGS. 4-7 disclose some particular features of the inner panel 202 that permit it to conduct air in the manner described above. First, it is relatively narrow along its rear edge 216 and widens as it extends forward to the front edge 215. The central raised region 228 of the inner panel 202 bulges upward as compared to the two left and right depressed side regions 230, 232, respectively that extend fore-and-aft on either side of the central raised region. This accommodates the air cleaner and the combustion air intake ducts that are disposed underneath and quite close to the central raised region 228 of the inner panel 202 when the hood is closed.

By depressing the two side regions, two channels are created that extend from top opening 118 down either side of the hood.

It will be understood that changes in the details, materials, steps, and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. Accordingly, the following claims are intended to protect the invention broadly as well as in the specific form shown.

We claim:

1. An engine hood with integral air conduit for a tractor, the tractor having a forwardly facing generally vertical radiator, an internal combustion engine disposed directly behind the radiator, and cooling fan for pulling air through the radiator that is disposed between the radiator and the engine, the hood comprising:
an outer shell, including
a planar top panel having an inner engine-facing surface and defining a combustion air aperture therethrough, said top panel being configured to be disposed above the engine and the radiator, said combustion air aperture having at least a rear portion that is disposed behind the radiator and above the radiator,
a vertical front panel coupled to the top panel and configured to extend vertically in front of the radiator and the engine, said front panel defining a cooling air aperture therein,
a vertical left side panel coupled to the top panel and the front panel and configured to extend down the left side of the engine, and
a vertical right side panel coupled to the top panel and the front panel and configured to extend down the right side of the engine,
wherein the top panel defines a combustion air aperture configured to conduct combustion air through the top panel, and further wherein at least a portion of the combustion air aperture is located behind the radiator; and
an inner panel that is fixed to the inner surface of the top panel to direct air passing through the rear portion of the combustion air aperture forward to the front of the radiator.

2. The engine hood of claim 1, wherein the inner panel and the top panel define a cooling air conduit therebetween to direct the combustion air forward from behind and above the radiator to the front of the radiator.

3. The engine hood of claim 2 wherein the inner panel has a rear edge, a left side edge and a right side edge that abut the outer shell, and further wherein the inner panel has a forward edge that abuts the radiator.

4. The engine hood of claim 3, wherein the inner panel is disposed to block radiator exhaust airflow from passing from the rear of the radiator to the front of the radiator over the top of the radiator.

5. The engine hood of claim 4, wherein the inner panel abuts the hood and the radiator such that substantially all air passing through the combustion air aperture is directed toward the front of the radiator.

6. The engine hood of claim 5, wherein the inner panel sealingly abuts a combustion air intake tube that extends over the top and toward the front of the radiator.

7. A hood for a work vehicle that defines an integral air channel, the work vehicle having a generally vertical radiator, an internal combustion engine disposed behind the radiator, and cooling fan disposed between the radiator and the engine to pull cooling air therethrough, the hood comprising:
an outer enclosure, including
a planar top wall having an inner engine-facing surface that defines an air transmitting aperture therethrough, said top wall being disposed above the engine and the radiator, said air transmitting aperture having a rear portion that is disposed both horizontally behind the radiator and vertically above the radiator,
a vertical front wall coupled to the top wall and configured to extend vertically in front of the radiator and the engine, said front wall defining a cooling air aperture therein,
a vertical left side wall coupled to the top wall and the front wall and configured to extend down the left side of the engine, and
a vertical right side wall coupled to the top wall and the front wall and configured to extend down the right side of the engine; and
an inner panel that is fixed to the inner surface of the top wall to direct air passing through the rear portion of the air transmitting aperture forward to the front of the radiator

8. The hood of claim 7, wherein the inner panel and the top wall define a cooling air channel therebetween to direct combustion air passing through the air transmitting aperture horizontally forward from behind to in front of the radiator.

9. The hood of claim 8 wherein the inner panel abuts the outer enclosure along its rear edge, its left side edge and its right side edge, and further wherein the inner panel has a forward edge that abuts the radiator.

10. The hood of claim 9, wherein the inner panel is disposed to block exhaust airflow from the radiator air outlet over the top of the radiator to the radiator air inlet.

11. The hood of claim 10, wherein the inner panel abuts the hood and the radiator such that substantially all air passing through the combustion air aperture is directed toward the front of the radiator.

12. The hood of claim 11, wherein the inner panel sealingly abuts a combustion air intake tube that extends from behind the radiator over the top of the radiator.

13. A vehicle hood for a vehicle having a forwardly facing vertical radiator, an internal combustion engine disposed behind the radiator, and cooling fan disposed between the radiator and the engine to pull cooling air through the radiator, the hood comprising:
an outer shell, including
a top panel having an inner surface and defining an air aperture therethrough, said top panel being disposed above both the engine and the radiator, said air aperture having a rear portion that is disposed behind the radiator and above the radiator, and a front portion that is disposed vertically above and horizontally in front of the radiator,
a forward facing panel coupled to the top panel and configured to cover the front of the radiator, said forward-facing panel defining a cooling air aperture therein for conducting engine cooling air into the air inlet of the radiator,
a left side panel coupled to the top panel and the forward-facing panel that extends down the left side of the engine, and
a right side panel coupled to the top panel and the forward-facing panel that extends down the right side of the engine; and
an inner panel that is fixed to the inner surface of the outer shell and abuts the top of the radiator to direct air passing through the rear portion of the air aperture forward to the front of the radiator.

14. The engine hood of claim 1 3, wherein the inner panel and the top panel define a cooling air path therebetween to direct the combustion air forward from behind and above the radiator to the front of the radiator.

15. The engine hood of claim 14 wherein the inner panel abuts the hood along its rear edge its left side edge and its right side edge, and further wherein the inner panel has a forward edge that abuts the radiator.

16. The engine hood of claim 15, wherein the inner panel is disposed to block radiator exhaust airflow from passing from the rear of the radiator to the front of the radiator over the top of the radiator.

17. The engine hood of claim 16, wherein the inner panel abuts the hood and the radiator such that substantially all air passing through the combustion air aperture is directed toward the front of the radiator.

18. The engine hood of claim 17, wherein the inner panel sealingly abuts a combustion air intake tube that extends over the top of the radiator and toward the front of the radiator.
